(19) United States
(12) Patent Application Publication
(10) Pub. No.: US 2011/0128161 A1
(43) Pub. Date: Jun. 2, 2011

(54) VEHICULAR WARNING DEVICE FOR PEDESTRIANS

(75) Inventors: Hong S. Bae, Sterling Heights, MI (US); Jihan Ryu, Rochester Hills, MI (US)

(73) Assignee: GM GLOBAL TECHNOLOGY OPERATIONS, INC., Detroit, MI (US)

(21) Appl. No.: 12/627,062

(22) Filed: Nov. 30, 2009

(51) Int. Cl. G08G 1/00; G08B 21/00; B60Q 1/00

(52) U.S. Cl. 340/901; 340/686.6; 340/435

(57) ABSTRACT

A pedestrian warning system includes a sensing device that is provided on the vehicle for detecting a pedestrian within a predetermined zone around the vehicle. A warning device on the vehicle generates a warning signal perceived by the pedestrian outside the vehicle indicating a presence of the vehicle. A speed sensor senses a speed of the vehicle. A controller is configured to receive a signal from the sensing device indicating the detection of the pedestrian within the predetermined zone. The controller determines whether the speed of the vehicle is within a predetermine speed range. The controller actuates the warning device for warning the pedestrian of the close proximity to the vehicle in response to determining the vehicle traveling at a respective speed is within the predetermined speed range and detecting the presence of the pedestrian within the predetermined zone.

### BACKGROUND OF INVENTION

An embodiment relates generally to pedestrian detection and warning systems.

In heavily populated metropolis cities, pedestrians and vehicles co-exist in a very close environment. Pedestrians are at many times walking or standing less than one foot from a slow moving vehicle. Due to the density of the traffic within a heavy populated city, vehicles often move at very slow speeds (e.g., less than 10 mph). As a result, pedestrians do not distance themselves from the vehicles; rather, pedestrians may walk, stand, or ride bikes just inches from slow moving vehicles.

Pedestrians are typically aware of vehicles in close proximity to them due to the sound of the running engine. However, vehicles are becoming increasingly quieter during engine-on operations, and therefore, the pedestrians are less likely to hear a vehicle in close proximity. The reduction in noise of the engine is due to enhanced noise suppression as well as the increasing use of electric and hybrid electric vehicles. The actuation of the horn by the driver, although effective, is often viewed as a rude behavior and requires manual intervention by the driver of the vehicle. Some drivers are reluctant to use their horn to warn the pedestrians since it viewed as rude behavior and since they may underestimate the danger to the pedestrian.

### SUMMARY OF INVENTION

An advantage of an embodiment of the invention is the autonomous warning of the pedestrian within a predetermined distance of the vehicle when the vehicle is traveling less than a predetermined speed.

An embodiment contemplates a pedestrian warning system for a vehicle. A sensing device is provided on the vehicle for detecting a pedestrian within a predetermined zone around the vehicle. A warning device on the vehicle generates a warning signal perceived by the pedestrian outside the vehicle indicating a presence of the vehicle. A speed sensor senses a speed of the vehicle. A controller is configured to receive a signal from the sensing device indicating the detection of the pedestrian within the predetermined zone. The controller determines whether the speed of the vehicle is within a predetermine speed range. The controller actuates the warning device for warning the pedestrian of the close proximity to the vehicle in response to determining the vehicle traveling at a respective speed is within the predetermined speed range and detecting the presence of the pedestrian within the predetermined zone.

An embodiment contemplates a method of alerting a pedestrian to the presence of a vehicle. A determination is made whether the vehicle has a vehicle speed greater than zero and less than a predetermined speed. A presence of the pedestrian is detected proximal to the vehicle in response to the speed of the vehicle being greater than zero and less than a predetermined speed. A determination is made whether the pedestrian is within a predetermined distance of the vehicle. A warning system is actuated for alerting the pedestrian of the vehicle being proximal to pedestrian.

### BRIEF DESCRIPTION OF DRAWINGS

FIG. 1 is a plan view of a vehicle sensing pedestrians according to an embodiment of the invention.

FIG. 2 is a plan view of a predetermined detection zone of the vehicle pedestrian sensing system according to an embodiment of the invention.

FIG. 3 is a block diagram of a pedestrian warning system according to an embodiment of the invention.

FIG. 4 is a flowchart of a method for warning pedestrians of proximal vehicle according to an embodiment of the invention.

### DETAILED DESCRIPTION

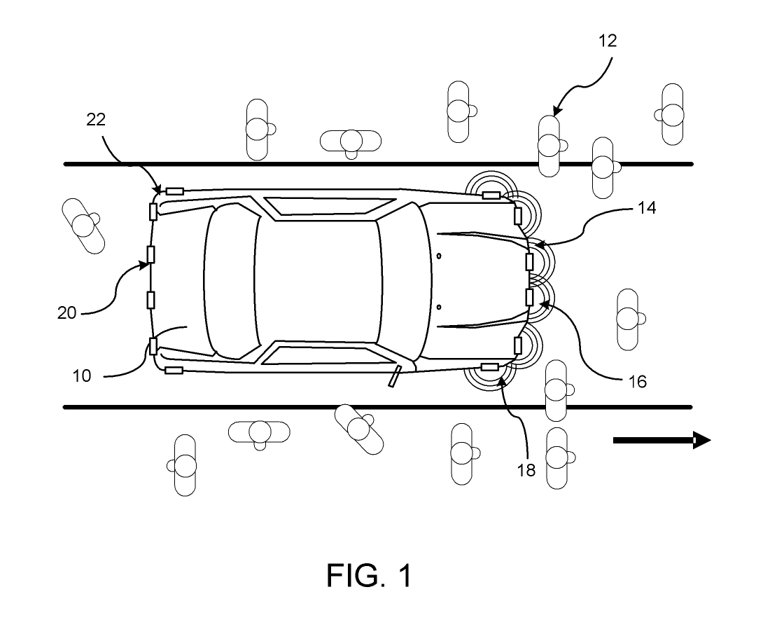

There is shown in FIG. 1, a vehicle 10 traveling along a roadway in a densely populated area where a plurality of pedestrians 12 travels on all sides of the vehicle 10. The vehicle 10 travels within a densely populated area at slow speeds due to traffic congestion caused by the excessive number of vehicles on the road and number of pedestrians crossing the roads at intersections. The plurality of pedestrians 12 includes walking pedestrians, jogging pedestrians, or cycling pedestrians in the roadway and on nearby sidewalks. Roadways may also include pedestrian lanes disposed adjacent to the curb in the road and is used for runners and bicyclers.

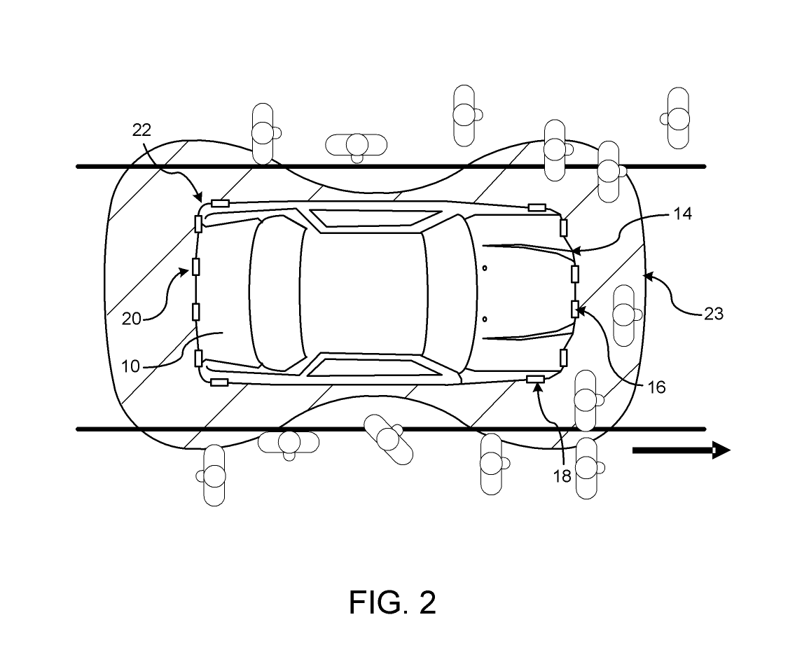

The vehicle is equipped with a sensing device 14 that includes one or more sensors or like devices that are regionally disposed around the vehicle for sensing pedestrians proximate to the vehicle 10. The sensors may be disposed at the front of the vehicle 16 and the front corners of the vehicle 18 in addition to the rear of the vehicle 20 and the rear corners of the vehicle 22. The pedestrian warning system described herein identifies a pedestrian when the pedestrian is within a predetermined range of the vehicle for warning the pedestrian. A predetermined zone is shown generally as 23 in FIG. 2. The predetermined zone 23 may be a full detection region emitted by the sensing device 14 or may be part of the detection region for determining whether the pedestrian is within the predetermined range of the vehicle for warning the pedestrian. Portions of the predetermined zone 23 may only be enabled that relate to regions that are affected by the path of travel of the vehicle. That is, if the vehicle is traveling in a forward direction, then there should be no concerns of pedestrians to the rear of the vehicle since the vehicle is moving in a forward direction. Therefore, if the vehicle 10 is traveling in a forward direction, the pedestrian warning system senses pedestrians located at front of the vehicle 16 and the front corners of the vehicle 18 using the respective sensors disposed substantially at the front of the vehicle. Similarly, when the vehicle is in a reverse gear, the pedestrian warning system detects pedestrians disposed at the rear of the vehicle 20 and rear corners of the vehicle 22 using the respective sensors disposed substantially at the rear of the vehicle. Pedestrians to the sides of the vehicle are readily able to see the vehicle through their peripheral vision and are not substantially in a path of travel of the vehicle and therefore are side sensors are note required; however, in alternative embodiments, side sensors for sensing pedestrians to the sides of the vehicle may be incorporated if desired. The pedestrian warning system aims to warn a pedestrian that is unaware of the presence of the vehicle when the pedestrian is in close proximity to the vehicle.

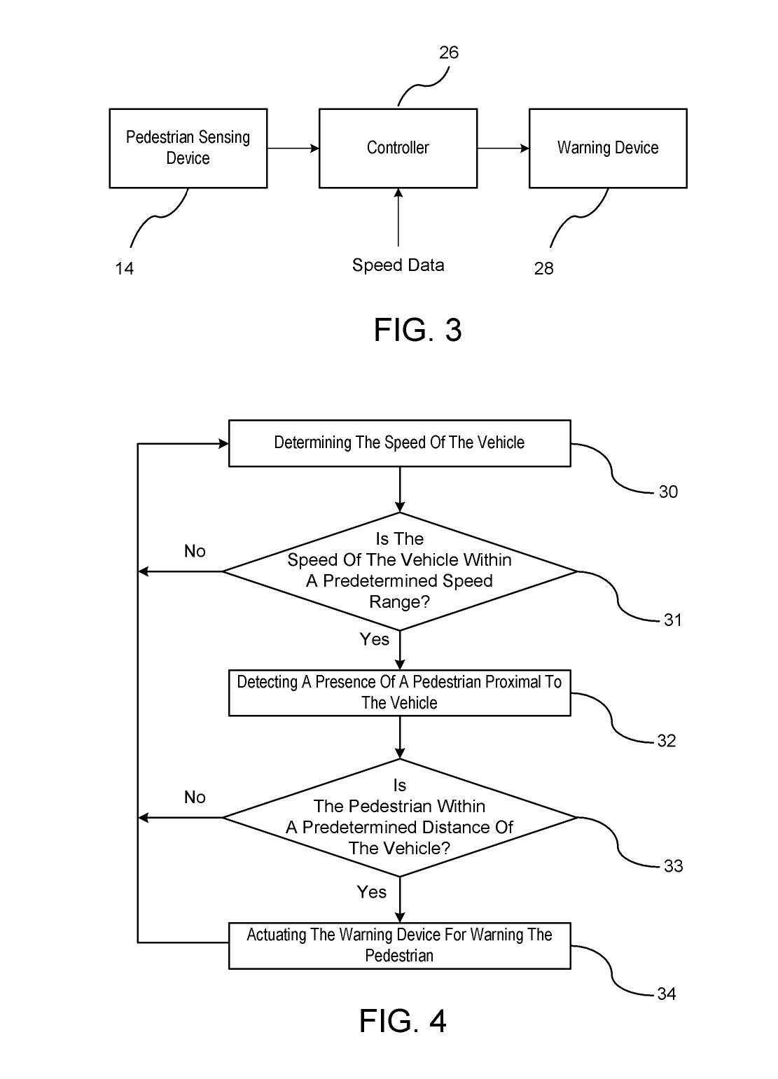

FIG. 3 illustrates a block diagram for the pedestrian warning system. The pedestrian warning system includes the pedestrian sensing device 14 for sensing respective pedestrians, a controller 26 for processing the signals received from the sensing device 14, and a warning device 28 for warning the pedestrian.

The sensing device 14 may include, but is not limited to, a proximity-based sensing device, a vision-based sensing device, a vision stereo sensing device, an ultrasonic-based sensing device, a radar-based sensing device, a light-based sensing device, or a capacitive-based sensing device. The various sensing devices described herein may be capable of providing both a signal identifying the pedestrian and a measured distance from the vehicle to the pedestrian, or may require additional processing for determining such information such as identification of a human or the distance to the pedestrian. For example, a proximity sensing device typically utilizes proximity sensors that detect objects. Proximity sensors typically do not distinguish humans from non-humans; however, such devices are relatively inexpensive and can be calibrated to detect objects only within the predetermined range. Other sensing devices such as the capacitive sensing device can be calibrated to identify the presence of a human within the sensed region. More sophisticated sensing devices such as the vision-based sensing device utilizes a camera. The camera captures an image and the data from the image is processed for distinguishing the human from other non-human objects in the captured image. In addition, the distance from the vehicle to the pedestrian may be determined from the data of the captured image. Sensing devices such as those described above are presently utilized on vehicles for various reasons such as object detection, park assist, or vision enhancement. The pedestrian warning system could utilize the existing sensing device already utilized on the vehicle for providing pedestrian detection information.

The controller 26 is configured to receive a signal from the sensing device. The controller 26 may be a stand-alone controller provided exclusively for the pedestrian warning system or may utilize any existing controller of the vehicle such as, but not limited to, a body control module. The received signal from the sensing device 14 indicates the presence of the pedestrian. The received signal may include data that simply indicates that an object is present within a predetermined range of the vehicle or may include data that requires further analysis. Analyzing the data, as described earlier, may include processing the data for distinguishing between human objects and non-human objects and/or determining the distance of an identified pedestrian to the vehicle. The controller 16 may also receive a speed signal that is indicative of the current speed of the vehicle. The speed of the vehicle is compared to a predetermined speed range to determine whether the warning should be issued. Preferably, warnings to pedestrians are provided when the vehicle speed is greater than zero but less than a predetermined speed. The predetermined speed is a maximum speed that the vehicle must travel slower than in order to issue the warning. Preferably, the maximum speed is set to a speed somewhere in the range of 10 mph-20 mph. If the vehicle is traveling at a fast rate of speed, then it is unlikely that the vehicle is traveling in a populated area where pedestrians are either walking or standing near the road. As described early, pedestrians disposed in or near the road likely occur in densely populated areas where pedestrian travel is highly populated and vehicle traffic speed are relatively slow speeds. It is under these conditions that pedestrians often do not pay as much attention to surrounding vehicles as pedestrians rely on the vehicle driver to take notice of them and provide them with the right of way. Examples of such areas include large metropolis cities and universities. Alternatively, the pedestrian warning system may utilize a predetermined speed greater than 20 mph to accommodate systems where sensing a pedestrian at an increased vehicle speed is demanded.

The controller 26, after determining that a respective pedestrian is within the predetermined distance to the vehicle and that the vehicle is traveling with the predetermined speed range, actuates the warning device 28. The warning device 28 is used to alert a respective pedestrian of their close proximity to the vehicle. The warning device 28 may include, but is not limited to, audible warning devices or visual warning devices. Audible warning devices are preferred since these devices do not require that the vehicle be in the pedestrian's sight for warning the pedestrian. An audible notification would suffice when the presence of the vehicle is to the backside of the pedestrian. Audible warnings may include, but are not limited to, noises generated by horn, sirens, or voice-synthesized devices which alert a respective pedestrian to the presence of the nearby vehicle. Visual warnings may be used to assist those pedestrians that are hearing impaired. Visual warning may include, but are not limited to, a flashing or a strobing of lights, a flashing pattern of lights, or color changes in lights. Visual warnings would be more beneficial during nighttime hours. Alternatively, a combination of the audible warnings and visual warnings may be actuated to alert the pedestrian. The warning device 28 is actuated in response to determining that a pedestrian is within a predetermined distance of the vehicle when the vehicle is traveling within the predetermined speed range.

FIG. 4 illustrates a flowchart of a method for actuating a warning to a pedestrian. A vehicle is provided having a warning device for alerting a pedestrian to the presence of a vehicle in close proximity to the vehicle. In step 30, the current speed that the vehicle is traveling is determined.

In step 31, a determination is made whether the current vehicle speed is within a predetermined speed range, specifically greater than zero mph and less than the predetermined speed. If the determination is made that the vehicle speed is not within the predetermined speed range, then the vehicle returns to step 30 to monitor the vehicle speed. If the determination is made that the vehicle speed is within the predetermined speed range, then the vehicle proceeds to the step 32.

In step 32, a pedestrian is detected proximal to the vehicle. The pedestrian may be detected by any of the respective devices described herein.

In step 33, a determination is made whether the pedestrian is within a predetermined distance of the vehicle. The determination may be determined by a respective sensing device detecting the pedestrian (e.g., the sensor is calibrated so that the emitted field only radiates within the predetermine distance) or the controller process the sensor data received from the sensing device to determine whether the pedestrian is within the predetermined distance of the vehicle. If the determination is made, in step 33, that the pedestrian is not within the predetermined distance of the vehicle, then a return is made to step 30 to monitor the vehicle speed and sense for a next pedestrian. If the determination is made, in step 33, that the pedestrian is within the predetermined distance of the vehicle, then the routine proceeds to step 34.

In step 34, the warning device is actuated for alerting the pedestrian to the presence of the vehicle that is within close proximity to the pedestrian. It should be understood that parallel processing paths may be performed using the method described herein for each pedestrian should more than one pedestrian be detected within one of the detection regions about the vehicle at a same instance of time.

While certain embodiments of the present invention have been described in detail, those familiar with the art to which this invention relates will recognize various alternative designs and embodiments for practicing the invention as defined by the following claims.

What is claimed is:

1. A pedestrian warning system for a vehicle comprising:
a sensing device on the vehicle for detecting a pedestrian within a predetermined zone around the vehicle;
a warning device on the vehicle for generating a warning signal perceived by the pedestrian outside the vehicle indicating a presence of the vehicle;
a speed sensor for sensing a speed of the vehicle; and
a controller configured to receive a signal from the sensing device indicating the detection of the pedestrian within the predetermined zone, the controller determining whether the speed of the vehicle is within a predetermine speed range;
wherein the controller actuates the warning device for warning the pedestrian of the close proximity to the vehicle in response to determining the vehicle traveling at a respective speed is within the predetermined speed range and detecting the presence of the pedestrian within the predetermined zone.

2. The pedestrian warning system of claim 1 wherein the warning device includes an audible warning device.

3. The pedestrian warning system of claim 1 wherein the warning device includes a visual warning device.

4. The pedestrian warning system of claim 1 wherein the sensing device includes a proximity sensor.

5. The pedestrian warning system of claim 1 wherein the sensing device includes a vision-based sensing device.

6. The pedestrian warning system of claim 1 wherein the sensing device includes a stereo vision camera.

7. The pedestrian warning system of claim 1 wherein the sensing device includes an ultrasonic sensor.

8. The pedestrian warning system of claim 1 wherein the sensing device includes a radar transceiver.

9. The pedestrian warning system of claim 1 wherein the sensing device includes a light-based sensing device.

10. The pedestrian warning system of claim 10 wherein the sensing device includes a capacitive-based sensing device.

11. The pedestrian warning system of claim 1 wherein the predetermined zone includes a predetermined distance of the vehicle.

12. The pedestrian warning system of claim 10 wherein the controller determines a distance of the pedestrian to the vehicle based on the signal provided by the sensing device.

13. A method for alerting a pedestrian to the presence of a vehicle, the method comprising the steps of:
determining whether the vehicle has a vehicle speed greater than zero and less than a predetermined speed;
detecting a presence of the pedestrian proximal to the vehicle in response to the speed of the vehicle being greater than zero and less than a predetermined speed;
determining whether the pedestrian is within a predetermined distance of the vehicle; and
actuating a warning system for alerting the pedestrian of the vehicle being proximal to pedestrian.

14. The method of claim 13 wherein the warning system generates an audible warning.

15. The method of claim 13 wherein the warning system generates a visual warning.

16. The method of claim 13 wherein the step of detecting a presence of the pedestrian proximal to the vehicle includes sensing an exterior region proximal to the vehicle and providing sensed signals from a sensing device to a controller for determining the presence of the pedestrian.

17. The method of claim 16 wherein the pedestrian is detected by the use of a vision-based imaging device.

18. The method of claim 16 wherein the pedestrian is detected by the use of ultrasonic-based sensing device.

19. The method of claim 16 wherein the pedestrian is detected by the use of radar-based sensing device.

20. The method of claim 16 wherein the pedestrian is detected by the use of a light-based sensing device.
